(19) United States
(12) Patent Application Publication
(10) Pub. No.: US 2016/0033010 A1
(43) Pub. Date: Feb. 4, 2016

(54) PLANETARY GEAR BOX

(71) Applicant: ORBITAL 2 LIMITED, Leamington Spa, Warwickshire (GB)

(72) Inventor: Vilem Rosko, Starkov (CZ)

(21) Appl. No.: 14/775,182

(22) PCT Filed: Mar. 11, 2014
(86) PCT No.: PCT/GB2014/050716

§ 371 Date: Sep. 11, 2015

(30) Foreign Application Priority Data
Mar. 12, 2013 (GB) 1304412.8

(51) Int. Cl. F16H 1/46; F03D 11/02; F03D 1/06

(52) U.S. Cl. CPC F16H 1/46; F03D 1/06; F03D 11/02

(57) ABSTRACT

A planetary gearbox (101) for a renewable energy turbine is disclosed. The gearbox comprises a planetary gearbox (101) and at least one service cable (110) extending through said planetary gearbox. For example, the service cable (110) may be for the supply of power to and/or data from a rotor of a turbine. The service cable (110) enters the gearbox (101) through a fixed planet stage (106c) of the gearbox and extends through a central shaft (130) to the stationary portion of a slip ring (120) assembly for providing, in use, a connection to a rotor of a turbine. The central shaft (130) may for example extend only partially through the gearbox. The service cable (110) may, for example, enter the output side of the gearbox at a location which is radially offset from the central axis of the gearbox.

### FIELD OF THE INVENTION

The present invention relates to a planetary gear box for a renewable energy turbine and to a renewable energy turbine including a planetary gear box.

### BACKGROUND OF THE INVENTION

Renewable energy turbines (referred to herein as “turbines”), are used for power generation from renewable sources. For example wind, tidal or hydro-electric turbines, generally utilise high-speed generators which may, for example, run at 1500 rpm but are driven by rotors which are driven by the wind or water at low and variable rotational speeds. As such, a gearbox is generally situated between the rotor and generator and must be able to provide a large gear ratio whilst handling very large loads. Thus, modern turbines typically use planetary (or “epicyclic”) gearboxes.

It is often necessary to provide services to turbine rotors for control or data capture. The cabling for such services must generally be provided to the hub of the rotor which is connected to the front of the gearbox. As such, the cabling must generally pass through the gearbox. In most conventional planetary gearbox arrangements for turbines the final output is typically via a “parallel” output shaft which is offset from the main axis of the gearbox (said main axis being coaxial with rotor axis). One advantage of such a parallel output stage is that a hollow central shaft may be provided which extends fully through the gearbox, from the input shaft proximal to the rotor to the rear of the gearbox proximal to the output, and through which the services to the rotor may be provided. Typically, a slip ring assembly is provided at the rear of the gearbox such that the services may rotate with the hollow rotating shaft and rotor. Such an arrangement is shown schematically in FIGS. 1 and 2 (and described in further detail below).

In some turbines it may, however, be desirable to utilise a fully coaxial planetary gearbox (i.e. a gearbox in which the output shaft and input shaft are coaxial). For example, it may be desirable to connect the output of the gearbox to an intermediate stage (such as a variable ratio gearbox) before connection to the generator or to a hybrid generator-gearbox such that a parallel output may be undesirable. Further, a fully coaxial gearbox may enable a reduction in the maximum cross sectional area of the nacelle in which stationary components of the turbine are provided (which is advantageous to the efficiency of the rotor).

Accordingly, embodiments of the invention seek to provide an alternative planetary gearbox arrangement which provides greater flexibility in providing services to the rotor and may, for example, negate the need to provide a hollow shaft which extends fully through the centre of the gearbox.

### SUMMARY OF INVENTION

According to a first aspect of the present invention there is provided a planetary gear box for a renewable energy turbine comprising: a planetary gearbox; and at least one service cable extending through said planetary gear box; wherein the service cable enters the gear box through a fixed planet stage of the gear box and extends through a central shaft to the stationary portion of a slip ring assembly for providing, in use, a connection to a rotor of a turbine.

Thus, by utilising a fixed planet stage of the gear box the cable in embodiments of the invention is able to enter the gearbox through a grounded (i.e. non-rotating) part of the gearbox and may be only subsequently routed to a central shaft. Advantageously, this may provide the gearbox designer with a greater degree of freedom in arranging the cable routing and/or the gearbox stages. For example, the need to provide a full length hollow shaft extending through the gear box may be removed.

A particular advantage of some embodiments of the invention may be in the sizing and design of the final stage of the gearbox which is often the most highly stressed and least durable stage of the gearbox. Depending upon the particular turbine arrangement it may be undesirable or impossible to provide a hollow shaft in the intermediate stage and/or generator. Thus, embodiments of the invention may advantageously enable a solid shaft to be used.

Further, in some arrangements it may be considered undesirable to pass services through a rotating flexible coupling which provides the drive connection, and additionally torque overload protection between gearbox and driven device(s). Thus, embodiments of the invention may advantageously obviate this disadvantage of prior art arrangements.

The slip ring assembly may typically be provided proximal to the input shaft of the gearbox (and may, therefore, be proximal to the turbine rotor). Thus, in contrast to typical existing designs, the cable may be stationary (i.e. non-rotating) for the substantial portion of its passage through the gearbox. The cable in the central shaft may be stationary.

A cable guide may be provided to define a fixed path for the cable.

At least a portion of the service cable may be arranged to run in a generally radial direction within the gearbox. The service cable may enter the output side of the gearbox at a location which is radially offset from the central axis of the gearbox. In contrast, it will be appreciated that the portion of the cable which extends through a central shaft will generally be considered to be aligned with the central axis of the gearbox.

The cable will typically be routed in an at least partially serpentine path from the fixed planet stage to the central shaft. For example the cable may follow an s-shaped path from the planet stage toward the central shaft (the skilled person will, for example, appreciate that any changes in direction of the path of the cable should be provided with a curve having a minimum radius of curvature selected based upon the size of the cable).

The service cable may be routed through any suitable part of the fixed planet stage of the gearbox which enables the cable to be stationary. For example the cable may be routed through the planet gear carrier of said fixed planet stage of the gearbox. Alternatively, the service cable may be routed through a planet gear of said fixed planet stage of the gearbox. For example, the cable may extend through the shaft of the planet gear.

The planetary gearbox may comprise a multi-planet planetary gearbox. Typically, for example, the planetary gearbox may have multiple stages. The planetary gearbox may, for example, incorporate the use of flexible pins.

The gearbox may be a fully coaxial gearbox. Embodiments of the present invention may be particularly beneficial in use with a fully coaxial planetary gearbox since a solid output shaft may be provided without impacting on the service cabling.

The central shaft may for example extend only partially through the gearbox. For example, the coaxial output shaft may be solid.

It will be appreciated that any suitable fixed planet stage may be selected for the cable entry depending upon the particular gear box to which the invention is being applied and any other design constraints affecting the cable positioning. Typically, however, the fixed planet stage may be the final stage of the gearbox. Utilising the final stage of the gearbox may enable the cable to pass through the full extent of the gearbox.

The at least one service cable may be for the supply of power to the rotor (for example to the turbine blades). For example, the cable may be for the supply of power to a blade pitch control system.

The at least one service cable may be for the supply of data to and/or from the rotor (for example to and/or from the turbine blades). For example, the cable may be for a load monitoring system and/or a speed monitoring system.

The at least one service cable may comprise a plurality of cables. For example, the at least one cable may comprise a cable harness (i.e. a bundle of individual cables having a common routing). A plurality of cables may include both data and power cables.

Alternatively or additionally, the gearbox may be provided with multiple cable routings (for example each passing through a different fixed planetary stage or through different fixed planetary gears of a single gearbox stage). For example data and power cables may each be routed separately.

According to a further aspect of the invention there is provided a renewable energy wind turbine comprising a planetary gearbox as claimed in any preceding claim and a rotor which drives said gearbox, wherein the at least one slip ring assembly further comprises a rotating portion on or coupled to the rotor.

According to a further aspect of the invention there is provided a wind turbine comprising a planetary gearbox in accordance with an embodiment of the invention and a rotor which drives said gearbox, wherein the at least one slip ring assembly further comprises a rotating portion on or coupled to the rotor.

According to a further aspect of the invention there is provided a tidal turbine comprising a planetary gearbox in accordance with an embodiment of the invention and a rotor which drives said gearbox, wherein the at least one slip ring assembly further comprises a rotating portion on or coupled to the rotor.

According to a further aspect of the invention there is provided a hydro-electric turbine comprising a planetary gearbox in accordance with an embodiment of the invention and a rotor which drives said gearbox, wherein the at least one slip ring assembly further comprises a rotating portion on or coupled to the rotor.

The slip ring assembly may be arranged within the hub of the rotor. Advantageously, this provides simple access to the slip ring assembly during installation and maintenance.

The turbine typically further comprises a generator driven (directly or indirectly) by the gearbox. The turbine may further comprise a variable ratio gearbox driven by the planetary gearbox.

Whilst the invention has been described above extends to any inventive combination of features set out above or in the following description or drawings.

### BRIEF DESCRIPTION OF THE DRAWINGS

Specific embodiments of the invention will now be described in detail by way of example only and with reference to the accompanying drawings in which:

FIG. 1 is a schematic three-dimensional diagram of a conventional parallel planetary gearbox with a rotating slip ring tube;

FIG. 2 is a schematic cross-section representation of a conventional parallel planetary gearbox showing the service cable routing;

FIG. 3 is a schematic partial cross-section representation of a fully coaxial planetary gearbox showing the service cable routing in accordance with an embodiment of the invention; and

FIG. 4 is a schematic three-dimensional partial cross-section of a fully coaxial planetary gearbox showing the service cable routing in accordance with a further embodiment of the invention.

### DESCRIPTION OF AN EMBODIMENT

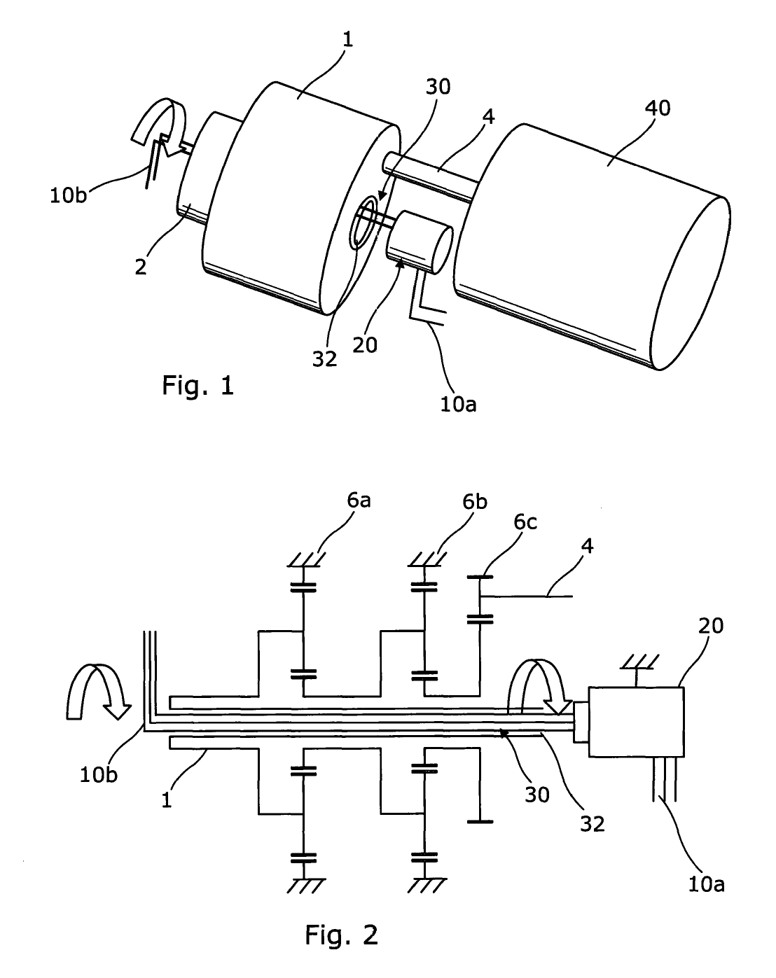

A conventional parallel planetary gearbox arrangement for use in turbines for power generation from renewable sources (particularly for wind or tidal turbines) is shown in FIGS. 1 and 2. The gearbox 1 is provided with an input shaft 2 which is driven, in use, by the rotors (not shown) of the turbine. A parallel axis output shaft 4 is provided which is arranged to drive a driven unit such as a generator 40. As best seen in FIG. 2, the gearbox comprises a series of planetary stages 6a, 6b and a parallel output gear 6c (which drives the output shaft 4) to achieve the desired gear ratio. Such planetary gearboxes are known in the art (such as the gearboxes designs commercially available from the present applicant) and the skilled person will appreciate that the particular gearbox arrangement will depend upon the particular turbine arrangement.

The rotor of the turbine generally requires electrical connections for power and/or signalling, such that service cables 10 are provided through the gearbox. For example, service cables may be provided for rotor monitoring and/or control (for example for pitch control systems). A hollow shaft 30 is, therefore, provided which extend through the full axial length of the gearbox 1 from the input shaft to an outlet 32 at the output end of the gearbox. The hollow shaft 30 rotates with the input shaft of the gearbox 1. A slip ring unit 20 is provided to allow the service cables 10 to transition from a stationary section 10a to a rotating section 10b within the shaft 30. The slip ring unit 20 is provided adjacent to the output end of the hollow shaft 30 (and outside of the gearbox 1). Thus, the service cables 10b at the gearbox 1 side of the slip ring 20 are able to rotate with the input shaft 2 (and therefore with the rotor) and the service cables 10a at the generator side of the slip ring unit 20 are stationary.

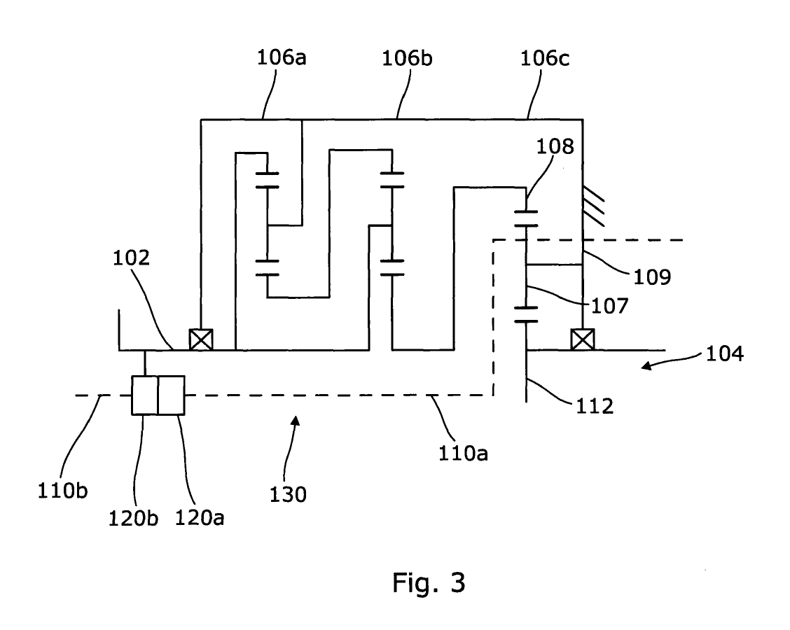

A planetary gearbox 101 according to an embodiment of the invention is shown as a partial schematic cross section in FIG. 3. As will be understood by the person skilled in the art this diagram shows only the schematic layout of the gearbox and shows only half of the gearbox (which will be generally symmetrical about its axis). The gearbox 101 comprises a fully coaxial planetary gearbox (i.e. a gearbox in which the output shaft 104 is coaxial with the input shaft 102) with three planetary gear stages 106a, 106b and 106c (although more or less stages may be provided as required). At least one stage of the gearbox has a fixed or grounded planet stage, and in the illustrated example both the first stage 106a and final stage 106c have fixed planet gears. By way of example, the final stage 106c comprises a rotating sun gear 112 which is connected to the output shaft 104 by at least one fixed planet gear 107 (and typically a plurality of planet gears for load distribution) which engage an annulus gear 108 for providing the input to the stage.

As in known gearboxes (such as the above example), at least one service cable 110b (and typically a plurality of service cables) is provided for the rotor attached to the input cable 110a. The service cable must generally extend through the gearbox 101 from a rearward point to the rotor which it enters via the rotor hub.

In accordance with the embodiment of FIG. 3, the service cable (or cables) 110a enters the gearbox 101 at a rearward point 109 (for example at the surface adjacent to the output shaft 104) through a fixed planet gear 107. Thus, at the point of entry into the gearbox 101 the service cable 110a is fixed (i.e. non-rotating). The cable is then routed to a hollow shaft 130 within the gearbox 101. The hollow shaft 130 extends from the input shaft 102 to a rearward point within the gearbox 101 (but does not pass fully through the gearbox as in the prior art). The service cable enters the gearbox running in a direction which is along an axis which is parallel to and spaced radially apart from the main gearbox axis (which is the axis of the input 102, and in the case of a fully co-axial gearbox the output 102). As such, the fixed routing requires the cable 110 to undergo a dogleg with two changes in direction to reach the central axis of the gearbox. In other words, the cable enters the rear (i.e. output) side of the gearbox in a generally axial direction then runs at least partially in a radial direction so as to reach a central shaft of the gearbox through which it may run in the axial direction. The skilled person will appreciate that while in the schematic representation of FIG. 3 the changes in direction of the service cable 130 are shown as right angles in practice the cable 110 will have radiused corners (the minimum curvature of which will be determined by the type and size of cable(s) following the routing)

In contrast to prior art arrangements, the hollow shaft 130 does not have an outlet at the output end of the gearbox; rather the output shaft 104 is a solid shaft which is coaxial with the input shaft 102. This avoids any limitation on the dimensions of the output shaft 104 (which may typically be a relatively highly stressed component). At the forward end of the hollow shaft 130 the fixed service cable 110a is connected to the non-rotating portion 120a of a slip ring unit. The rotating portion 120b of the slip ring unit is connected to a rotating portion of the service cable 110b for connection to the rotor. Typically, the slip ring unit 120 is positioned proximal to the rotor (for example within the rotor hub for ease of access). As such, the stationary portion of the service cable 110a extends through substantially the full length of the gearbox 101 with only the forward most section of the service cable 110b arranged to rotate with the shaft 102 and rotor.

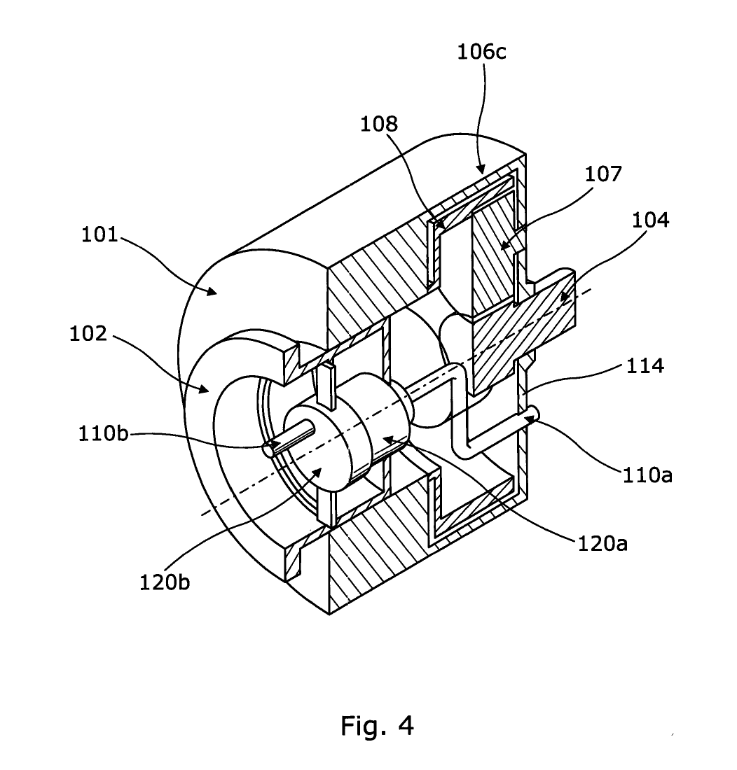

A three-dimensional partial cross-section of a further embodiment of the invention is shown in FIG. 4. This embodiment is generally similar to the embodiment of FIG. 3 and like reference numerals have been used for corresponding features. For clarity this embodiment shows only a single gearbox stage 106c but the skilled person will understand that multiple stages may be provided as in the previous embodiment. In accordance with the invention, the fixed portion of the cable 110a in this embodiment enters the gearbox 101 through a fixed planet stage 106c of the gearbox and extends through a central shaft to the stationary portion 120a of a slip ring 120. It will, however, be noted that in contrast to the embodiment of FIG. 3 the cable entry is through the planet carrier 114 (which supports and “grounds” the planet gear 107) of the fixed planet stage rather than through the fixed planet gear 107. In the illustrated embodiment the planet carrier 114 is formed integrally with the outer body of the gearbox 101 (although this may not be so in all gearbox arrangements).

While the invention has been described above with reference to one or more preferred embodiments, it will be appreciated that various changes or modifications may be made without departing from the scope of the invention as defined in the appended claims. For example, the skilled person will appreciate that the particular cable routing chosen will depend upon particular gearbox arrangement to which the gearbox is applied. As such, whilst the embodiments above provide a service cable which enter the gearbox parallel to the main gearbox axis in other embodiments it may be desirable to enter the cable at an inclined angle (which may reduce or substantially remove the dogleg in the cable routing)

1. A planetary gearbox for a renewable energy turbine comprising:
a planetary gearbox; and
at least one service cable extending through said planetary gearbox;
wherein the service cable enters the gearbox through a fixed planet stage of the gearbox and extends through a central shaft to the stationary portion of a slip ring assembly for providing, in use, a connection to a rotor of a turbine.

2. The planetary gearbox of claim 1, wherein the slip ring assembly is proximal to the input of the gearbox.

3. The planetary gearbox of claim 1 or 2, further comprising a cable guide defining a fixed path for the cable between the cable entrance and central shaft.

4. The planetary gearbox of any preceding claim, wherein at least a portion of the service cable extends in a radial direction through the gearbox.

5. The planetary gearbox of any preceding claim, wherein the service cable enters the output side of the gearbox at a location which is radially offset from the central axis of the gearbox.

6. The planetary gearbox of any preceding claim, wherein the service cable is routed through the planet gear carrier of said fixed planet stage of the gearbox.

7. The planetary gearbox of any of claims 1 to 5, wherein the service cable is routed through a planet gear of said fixed planet stage of the gearbox.

8. The planetary gearbox of any preceding claim, wherein the gearbox comprises a multi-planet planetary gearbox.

9. The planetary gearbox of any preceding claim, wherein the gearbox is a fully coaxial gearbox.

10. The planetary gearbox of any preceding claim, wherein the fixed planet stage is the final stage of the gearbox.

11. The planetary gearbox of any preceding claim, wherein the central shaft extends only partially through the gearbox.

12. The planetary gearbox of any preceding claim, wherein the at least one service cable is for the supply of power to the rotor.

13. The planetary gearbox of any preceding claim, wherein the at least one service cable is for the supply of data to or from the rotor.

14. The planetary gearbox of any preceding claim, wherein the at least one service cable is for turbine pitch control.

15. The planetary gearbox of any preceding claim, wherein the service cable comprises a cable harness.

16. A renewable energy turbine comprising a planetary gearbox as claimed in any preceding claim and a rotor which drives said gearbox, wherein the at least one slip ring assembly further comprises a rotating portion on or coupled to the rotor.

17. A turbine as claimed in claim 16, wherein the slip ring assembly is arranged within the hub of the rotor.

18. A turbine as claimed in claim 16 or 17, further comprising a variable gearbox connected to the output of the planetary gearbox.
